(19) United States
(12) Patent Application Publication
(10) Pub. No.: US 2005/0033599 A1
(43) Pub. Date: Feb. 10, 2005

(54) Printing on-the-fly barcoded documents

(76) Inventors: Didier Frantz, New York, NY (US); Olivier Attia, New York, NY (US); Ashish Muni, Flushing, NY (US)

Correspondence Address: Avi Outmezguine, Fourth Floor, 54 West 39th Street, New York, NY, 10018, US

(21) Appl. No.: 10/911,258

(22) Filed: Aug. 4, 2004

Related U.S. Application Data
(60) Provisional application No. 60/492,307, filed on Aug. 5, 2003.

(51) Int. Cl. G06F 17/60

(52) U.S. Cl. 705/1

(57) ABSTRACT

The present invention discloses a system and method for creating custom barcoded documents from preexisting lists. A user of the system first selects a list containing the desired products and item codes. Once the list has been selected, the user selects the desired format and layout of the catalog. A program located on the computer then generates the barcoded catalog utilizing the user's selected list and catalog format preferences. The document can then be saved to a file or printed out for ordering use.

### PARENT CASE TEXT

This application claims the benefit of provisional application No. 60/492,307 filed Aug. 5, 2003.

### FIELD OF THE INVENTION

The present invention relates to the field of creating catalogs for ordering supplies. More specifically, the present invention discloses a system and method for creating custom barcoded catalogs for ordering supplies.

### BACKGROUND

Currently, many retailers offer catalogs which can be used to order items via mail, telephone, or the Internet. Each item in the catalog is normally associated with an item code which is unique to that particular product. To place an order using the catalog, a user typically records all of the item codes and quantities for the items the user wishes to order. If the order is being placed via the mail, the user must fill out an order form and mail it to the retailer with payment information. Some retailers also offer ordering service via the telephone whereby an operator or an interactive voice response system acquires the order information from the user.

To order via the Internet from a catalog, a user must visit the retailer's website and fill out an online order form which is similar in form and content to an order form which would be utilized for mail order. However, ordering via the Internet is typically quicker than ordering by the mail since the order is being placed in real-time.

Most retail catalogs have the disadvantage that they are not customizable. Therefore, each time a user desires to place an order, he/she must sort through the catalog entries to find the products to order. Also, the user must rewrite or retype the item codes and quantities each time an order is placed. For large orders, this can be a tedious and time consuming process.

Therefore, there clearly exists a need for a system and method which enables users to create usable documents for ordering and reordering purposes. Such a system would be especially useful if used in conjunction with a preexisting barcode ordering system.

### SUMMARY OF THE INVENTION

The present invention provides a system and method which allows users to instantaneously print barcoded catalogs and labels for users which are created from a pre-existing list. This enables the users to print customized shelf labels, catalogs, or any other document of their products (frequently ordered items, acceptable items, etc.) immediately with no waiting time. The barcoded document is not limited to any specific format; it can be created in any electronic format including, but not limited to, PDF, Microsoft Word (.doc), Mircosoft Excel (.xls), RTF, and HTML.

To create a barcoded document on-the-fly, a user first selects the desired list from a plurality of pre-existing lists using a software application on a computer. Each list contains a list of products and their attributes. The attributes may include, but are not limited to, quantity, color, description, picture, price, barcode, barcode format, etc. The user then selects the preferred format for the barcoded document. As previously mentioned, the barcoded document may be created as a PDF, Microsoft Word file, Microsoft Excel file, etc. It should be apparent to one skilled in the art that any electronic format which is capable of storing text and graphics is compatible with the present invention.

The user is next prompted to select the layout of the barcoded document from a plurality of predefined layouts. For example, one layout may be called the “Professional Catalog” layout. In this layout, the document created would resemble a professional catalog from an office supply store or other similar merchant. Alternatively, the user may select an “Individual Label” layout which would create a document capable of printing each item on a separate label.

After the user has selected the desired list, document format, and document layout, the software program creates the barcoded document from the list and displays the list on-screen to the user. On each created document, the barcode for the item will be located directly next to the other attributes of the item. The created document can then be utilized to re-order office supplies and other goods which are contained on the created document. Barcode ordering systems compatible with the present invention are disclosed in co-pending U.S. patent application Ser. No. 09/883,933 entitled “System and method for scan-based input, storage and retrieval of information over an interactive communication network,” U.S. patent application Ser. No. 10/420,714 entitled “Integrating barcode scanner enabled services in existing e-commerce applications using a floating pop-up web window,” U.S. Provisional Patent Application No. 60/487,238 entitled “ScanClik VMI application,” and U.S. Provisional Patent Application No. 60/487,276 entitled “SuperCart.”

The document created by the user can either be saved to a file on the computer or instantaneously printed using a printer attached to the computer.

Therefore, it is an object of the present invention to provide a software program capable of instantaneously creating barcoded documents.

It is an additional object of the present invention to provide a software program which increases user satisfaction.

Another object of the present invention is to provide a software program which is capable of creating documents in many different formats.

It is yet another object of the present invention to provide a software program which allows a user to select the layout of the created document.

These and other objects of the present will be made clearer with reference to the following detailed description and accompanying drawings.

### BRIEF DESCRIPTION OF THE DRAWINGS

FIG. 1 depicts a flowchart depicting the steps utilized by a user to create a barcoded document.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment may be modified in form and content to be optimized for a wide variety of situations.

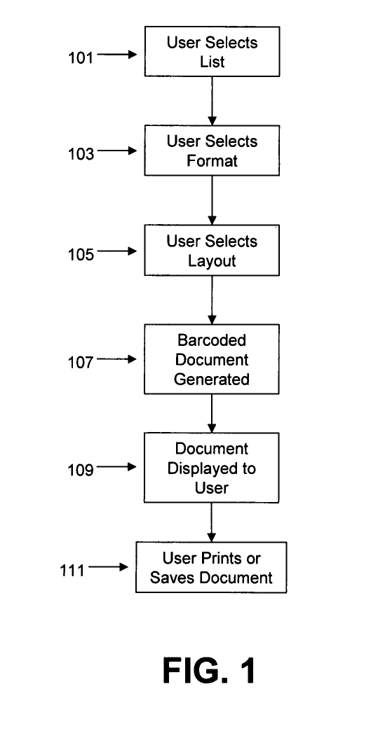

Referring first to FIG. 1, shown is a flowchart depicting the steps utilized by a user to create a barcoded document. To create a barcoded document on-the-fly, a user first selects the desired list from a plurality of pre-existing lists in step 101. Each list contains a list of products and their attributes. The attributes may include, but are not limited to, quantity, color, description, picture, price, barcode, barcode format, etc. The user then selects the preferred format for the barcoded document in step 103. For example, the barcoded document could be created as a PDF, Microsoft Word file, Microsoft Excel file, etc. It should be apparent to one skilled in the art that any electronic format which is capable of storing text and graphics is compatible with the present invention.

The user is next prompted to select the layout of the barcoded document in step 105. In the preferred embodiment, the layouts are stored in a file accessible by the computer program. The layouts may assume a variety of forms. For example, one layout may be called the “Professional Catalog” layout. In this layout, the document created would resemble a professional catalog from an office supply store or other similar merchant. Alternatively, the user may select an “Individual Label” layout which would create a document capable of printing each item on a separate label.

After the user has selected the desired list, document format, and document layout, the software program creates the barcoded document from the list in step 107 and displays the list on-screen to the user in step 109. On each created document, the barcode for the item will be located directly next to the other attributes of the item. The created document can then be utilized to re-order office supplies and other goods which are contained on the created document. Barcode ordering systems compatible with the present invention are disclosed in U.S. Provisional Application No. 60/487,238 entitled “ScanClik VMI application” and U.S. Provisional Application No. 60/487,276 entitled “SuperCart.”

The document created by the user can either be saved to a file on the computer or instantaneously printed using a printer attached to the computer in step 111.

While the foregoing embodiments of the invention have been set forth in considerable detail for the purposes of making a complete disclosure, it should be evident to one skilled in the art that multiple changes may be made to the aforementioned description without departing from the spirit of the invention.

1. A method for producing a barcoded document comprising the steps of:
selecting a list of items from a plurality of lists, wherein each of said items is associated with an alphanumeric code;
selecting a format for said barcoded document from a plurality of formats;
selecting a layout for said barcoded document from a plurality of layouts; and
generating said barcoded document using said list of items, said selected format, and said selected layout, wherein said barcoded document contains a machine readable code for each of said items on said barcoded document.

2. A method for producing a barcoded document according to claim 1, further comprising the steps of:
displaying said barcoded document on screen to a user; and
printing said barcoded document.

3. A method for producing a barcoded document according to claim 1, further comprising the step of:
saving said barcoded document to a storage medium.

4. A method for producing a barcoded document according to claim 1, wherein said format is at least one from the list comprising of a Microsoft Word document, a HTML page, a portable document format document, a Corel Word Perfect document, a text document, a JPEG image, a bitmap image, a PNG image, a TIFF image, and a PNG image.

5. A method for producing a barcoded document according to claim 1, wherein said layout is at least one from the list comprising of a landscape layout, a portrait layout, a professional catalog layout, and an individual label layout.

6. A method for producing a barcoded document according to claim 1, wherein said machine readable code is created from said alphanumeric code associated with each of said items.

7. A method for producing a barcoded document according to claim 1, wherein said machine readable code is at least one of the symbologies from the list comprising of UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, and Data Matrix.

8. A method for producing a barcoded document according to claim 1, wherein said alphanumeric code is a SKU code.
